(19) United States
(12) Patent Application Publication
(10) Pub. No.: US 2026/0355713 A1
(43) Pub. Date: Nov. 12, 2026

(54) METHOD FOR PREPARING CERIUM-DOPED GOETHITE ADSORPTION MATERIAL AND USE THEREOF

(71) Applicant: BEIJING NORMAL UNIVERSITY, Beijing (CN)

(72) Inventors: Xinhui LIU, Beijing (CN); Xin ZHANG, Beijing (CN); Liping LI, Beijing (CN); Handan ZHANG, Beijing (CN); Lu DONG, Beijing (CN); Pengcheng LI, Beijing (CN); Mengzhu XUE, Beijing (CN); Kening WANG, Beijing (CN); Guohui XIA, Beijing (CN); Bohan LI, Beijing (CN)

(21) Appl. No.: 19/647,783

(22) Filed: Apr. 14, 2026

(30) Foreign Application Priority Data
May 9, 2025 (CN) 202510597717.7

(51) Int. Cl. B01J 20/02; B01J 20/30; B01J 20/32; B01J 20/34; C02F 1/28; C02F 1/66; C02F 101/30

(52) U.S. Cl. CPC B01J 20/0229; B01J 20/0207; B01J 20/3071; B01J 20/3078; B01J 20/3085; B01J 20/3204; B01J 20/3217; B01J 20/3236; B01J 20/3433; B01J 20/3475; C02F 1/288; C02F 1/66; C02F 1/281; C02F 2101/30; C02F 2303/16

(57) ABSTRACT

Disclosed in the present disclosure are a method for preparing a cerium-doped goethite adsorption material and use thereof. The cerium-doped goethite adsorption material Ce—FeOOH consists of goethite FeOOH doped with metal cerium Ce; a doping amount of the Ce is 1.5-10.9 wt %, the Ce is supported on a surface of the FeOOH in a form of a Ce(III) and Ce(IV) mixed-valence state, and a proportion of Ce(III) is 17.8-30.0%. The Ce—FeOOH adsorption material maintains excellent adsorption stability in wide-pH range and high-ionic strength water bodies contaminated with extracellular antibiotic resistance genes (eARGs).

### CROSS-REFERENCE TO RELATED APPLICATIONS

The present application claims priority to Chinese patent application No. 202510597717.7, titled “METHOD FOR PREPARING CERIUM-DOPED GOETHITE ADSORPTION MATERIAL AND USE THEREOF”, filed on 9 May 2025, the entire contents of which are incorporated herein by reference.

### FIELD OF TECHNOLOGY

The present disclosure relates to the technical field of environmental functional materials, and in particular, to a method for preparing a cerium-doped goethite adsorption material and use thereof. Through controllable doping and surface modification techniques, the adsorption material achieves the efficient capture and removal of extracellular antibiotic resistance genes under complex water environmental conditions, and is suitable for the treatment of complex water body environments.

### BACKGROUND

In recent years, the dissemination of antibiotic resistance genes (ARGs) in aquatic environments has become a major challenge in the field of global public health. According to the 2021 report by the World Health Organization (WHO), the annual number of deaths caused by infections with drug-resistant bacteria has exceeded 1.27 million and is projected to rise to 10 million by 2050. Extracellular antibiotic resistance genes (extracellular ARGs, eARGs), which widely exist in water body environments in forms such as plasmids and free DNA fragments, exhibit significantly higher environmental persistence (with half-lives ranging from weeks to months) and horizontal transfer potential than intracellular ARGs. eARGs can enter the human body through pathways such as drinking water and irrigation water, inducing pathogenic bacteria to acquire drug resistance and posing a severe threat to the safety of the healthcare system.

Currently, technologies for the removal of eARGs from water bodies mainly include advanced oxidation, biodegradation, and adsorption methods. Their technical bottlenecks are as follows: advanced oxidation processes, such as ultraviolet (UV), persulfate (PS), and Fenton oxidation, can destroy DNA strand structures through radical attack; however, they have significant drawbacks, such as the risk of byproducts. Hydroxyl radicals (·OH) indiscriminately attack organic matter and may degrade macromolecular eARGs into smaller fragments (<500 bp) that are more readily taken up by bacteria, thereby promoting the spread of resistance. In addition, this method is costly, and treating water bodies entails high electricity consumption and necessitates the continuous addition of chemical reagents (such as H₂O₂), leading to increased operational expenses. Although biodegradation methods, such as phage-based or nuclease-functionalized biofilm technologies, have the advantage of specific recognition, functional enzymes exhibit poor tolerance in complex environments, and the environmental release of genetically engineered bacteria may trigger controversies regarding ecological safety. In contrast, adsorption methods require no other energy or reaction reagents; they are technically simple and environmentally friendly, and hold great potential for development. However, traditional adsorption materials also have limitations. For example, activated carbon exhibits low efficiency and poor selectivity; although nanoscale zero-valent iron (nZVI) possesses reductive degradation capability, it is prone to oxidative deactivation under aerobic conditions and can induce DNA strand breakage, generating shorter fragments that are more readily transferred; in natural water bodies (pH 7.0-8.0), eARGs carry a strong negative charge (Zeta potential≈−30 mV), whereas traditional metal oxide adsorbents (such as Al₂O₃ and Fe₃O₄) generally have an isoelectric point (pHpzc) exceeding 8.0, resulting in electrostatic repulsion; although commercial anion exchange resins can capture DNA via electrostatic attraction, they are significantly affected by competitive adsorption from humic acids. Therefore, it is very necessary to seek more effective and reliable adsorbents to achieve the efficient removal of free eARGs.

Goethite (FeOOH) is considered a promising adsorbent due to its characteristics, such as environmental friendliness and abundant surface hydroxyl groups; however, its intrinsic properties severely limit its adsorption efficiency for eARGs, such as surface charge mismatch, pore size mismatch, and environmental sensitivity. Based on the above drawbacks, in the present disclosure, cerium (Ce) is selected as the doping element. Its unique physicochemical properties overcome the limitations of traditional adsorption materials through the following mechanism: (1) enrichment of active sites and coordination bonding. After doping with element Ce, the surface hydroxyl density can be increased, or oxygen vacancy active sites can be introduced. Ce—OH groups (pKa≈6.8) are preferentially protonated at physiological pH, becoming strong coordination sites for DNA phosphate groups (pKa≈1.5). Ce—O—Fe bonds form electron transfer channels, enhancing the π-π stacking interactions with DNA bases and thereby improving adsorption. The formation of oxygen vacancies and the exposure of surrounding unpaired Ce(III)/Fe(III) sites can also provide more adsorption sites for eARGs. (2) Surface charge optimization and electrostatic attraction enhancement. After Ce³⁺ substitutes for Fe³⁺ in the FeOOH lattice, the tendency toward protonation is enhanced, and the isoelectric point of the doped material decreases, thereby increasing its electrostatic attraction capability toward negatively charged eARGs.

Based on the above theoretical basis, the element cerium-doped goethite adsorption material Ce—FeOOH is expected to achieve efficient, stable, and sustainable adsorption and removal of eARGs through multiple synergistic mechanisms, including coordination bonding enhancement, surface charge optimization, and anti-interference capability improvement.

### SUMMARY

Technical problems to be solved: aiming to solve the problems of low removal efficiency and poor environmental adaptability of existing adsorption materials for extracellular antibiotic resistance genes in water bodies, the present disclosure provides a cerium-doped goethite adsorption material (Ce—FeOOH) and a method for preparing same, which are applied to the remediation of water bodies contaminated with extracellular antibiotic resistance genes.

Technical solutions: a cerium-doped goethite adsorption material and a method for preparing same.

The cerium-doped goethite adsorption material Ce—FeOOH consists of goethite FeOOH doped with metal cerium Ce; the Ce is supported on a surface of the FeOOH in a form of a Ce(III) and Ce(IV) mixed-valence state, and a proportion of Ce(III) is 17.8-30.0%.

A method for preparing the cerium-doped goethite adsorption material includes the following steps:
S1. precursor treatment: placing FeOOH particles in a low-concentration acid solution to react under oscillation, then washing until neutral, and carrying out vacuum drying to obtain pre-treated FeOOH; and
S2. Ce ion supporting and purification: dissolving a cerium salt in water to obtain a cerium salt solution, mixing the cerium salt solution with the FeOOH, carrying out ultrasonic dispersion, and then carrying out a reaction under oscillation to form a composite solution; and finally, subjecting the composite solution to dialysis, and carrying out vacuum drying to obtain a Ce—FeOOH adsorption material.

Preferably, in step S1, the low-concentration acid solution is one or more of nitric acid, hydrochloric acid, and sulfuric acid solutions;

Preferably, in step S1, a time for the reaction under oscillation is 20-40 min, and a temperature for the vacuum drying is 40-60 °C.

Preferably, in step S2, the cerium salt solution is any one or more of cerium chloride, cerium nitrate, cerium sulfate, and hydrates thereof.

Preferably, in step S2, a doping amount of the Ce in the Ce—FeOOH adsorption material is 1.5-10.9 wt %.

Further, in step S2, the doping amount of the Ce in the Ce—FeOOH adsorption material is 10.9 wt %.

Preferably, in step S2, for the ultrasonic reaction, a frequency is 30-50 kHz, and a time is 20-40 min; for the reaction under oscillation, a temperature is 23-26 °C, a rotation speed is 170-190 rpm, and a time is 22-26 h.

Use of the Ce—FeOOH adsorption material in the removal of extracellular antibiotic resistance genes (eARGs) from a water body.

A method for removing extracellular antibiotic resistance genes (eARGs) from a water body using the Ce—FeOOH adsorption material includes the following steps:
S1. adjusting a pH of an eARG-contaminated water body to be treated to (4.0-8.0)+0.1, and adjusting a salinity of the water body to be treated to ≥10 mmol/L using a neutral salt;
S2. dispersing the Ce—FeOOH adsorption material into the water body to be treated, mixing under oscillation at 23-26 °C and 170-190 rpm for 30-120 min, and separating a Ce—FeOOH-eARGs complex via centrifugation; and
S3. immersing the complex in a NaOH solution, thereby achieving elimination of the eARGs from the water body and desorption and regeneration of the Ce—FeOOH material.

Preferably, in step S1, the pH of the water body to be treated is (4.0-7.0)±0.1. Further, in step S1, the pH of the water body to be treated is ≤7.0±0.1.

Preferably, in step S1, the salinity of the water body to be treated is 10-500 mmol/L.

Further, in step S1, the salinity of the water body to be treated is ≥10 mmol/L.

Preferably, in step S2, a dosage of the Ce—FeOOH adsorption material in the water body to be treated is 10-80 mg/L.

Further, in step S2, the dosage of the Ce—FeOOH adsorption material in the water body to be treated is ≥80 mg/L.

Preferably, in step S2, an adsorption time for the Ce—FeOOH adsorption material to remove eARG contamination from the water body is 0-360 min.

Further, in step S2, the adsorption time for the Ce—FeOOH adsorption material to remove eARG contamination from the water body is ≥60 min.

Preferably, when the pH of the water body to be treated in step S2 is 7.0±0.1, the salinity of the water body to be treated needs to be adjusted to ≥10 mmol/L, and a dosage of the Ce—FeOOH adsorption material is ≥80 mg/L.

Preferably, when the water body to be treated in step S2 satisfies one or more of pH<7.0±0.1 or salinity >10 mmol/L, a Ce—FeOOH adsorption material with a Ce doping amount of 10.9% is selected, and one or more of methods including an adsorption material dosage of 50-80 mg/L or shortening an adsorption time to 30-60 min is utilized.

Preferably, in step S3, a concentration of the NaOH solution is 0.05-0.2 mol/L, and a time for the desorption and regeneration is 30-360 min.

Further, in step S3, the concentration of the NaOH solution is 0.2 mol/L, and the time for the desorption and regeneration is 30 min.

Use of the above Ce—FeOOH adsorption material in the remediation of a water body contaminated with extracellular antibiotic resistance genes.

### Beneficial Effects

Compared with traditional adsorbents, the present disclosure has the following beneficial effects:
1. Improved adsorption efficiency: dual optimization of rapid kinetics and high adsorption capacity is achieved, not only achieving strong chelation with the phosphate groups of eARGs but also shortening the time for adsorption equilibrium.
2. Improved environmental adaptability: the modified material can adapt to a wide pH tolerance range, breaking through the bottleneck of pH limitation of traditional materials, and exhibits excellent performance in applications across various salinity ranges from freshwater to brackish water to saltwater.
3. Environmentally friendly sustainability: by utilizing low-cost raw materials in combination with a low-carbon preparation process, carbon emissions during material production are significantly reduced; meanwhile, through precise control over process parameters, the material structure is controlled, thereby providing an efficient, sustainable, and environmentally friendly solution for the treatment of eARG contamination.

### BRIEF DESCRIPTION OF THE DRAWINGS

FIG. 1 shows the adsorption effects of Ce—FeOOH adsorption materials C0-C5 with different Ce doping amounts on eARGs in a water body;

FIG. 2 shows the adsorption effects of a Ce—FeOOH adsorption material C5 at different dosages on eARGs in a water body;

FIG. 3 shows the adsorption effects of FeOOH and a Ce—FeOOH adsorption material C5 on eARGs at different concentrations in a water body, fitted using Langmuir and Freundlich adsorption models;

FIG. 4 shows the adsorption effects of a Ce—FeOOH adsorption material C5 at different pH values on eARGs in a water body;

FIG. 5 shows the adsorption effects of a Ce—FeOOH adsorption material C5 at different NaCl concentrations on eARGs in a water body;

FIG. 6 shows the elimination effect on eARGs adsorbed by a Ce—FeOOH adsorption material C5 under different NaOH concentrations;

FIG. 7 shows the recyclability of a Ce—FeOOH adsorption material C5 after desorption and regeneration with NaOH;

FIG. 8 shows the comparison of adsorption effects on eARGs in a water body between FeOOH doped with different metals and Ce-doped Fe₃O₄.

### DESCRIPTION OF THE EMBODIMENTS

To further understand the present disclosure, preferred embodiments thereof are described below in conjunction with examples.

The specific preferred examples are as follows:

### Example 1

This example showed a method for preparing a Ce—FeOOH adsorption material C5 with a Ce doping amount of 10.9 wt %, and an adsorption effect thereof on extracellular resistance gene (Amp) contamination in water, including the following steps:

(1) Preparation of a Ce—FeOOH Adsorption Material C5 with a Ce Doping Amount of 10.9 wt %:
S1. precursor treatment: FeOOH particles were placed in a 0.1 mol/L nitric acid solution for oscillation for 30 min, washed until neutral (pH=7.0±0.1), and subjected to vacuum drying at 50 °C to obtain pre-treated FeOOH;
S2. Ce ion supporting and purification: cerium(III) chloride heptahydrate (CeCl₃·7H₂O, 99.9%) was accurately weighed and dissolved in 50 mL of deionized water; the pre-treated FeOOH was added; ultrasonic dispersion was carried out at 40 kHz for 30 min, followed by a reaction at 25 °C and 180 rpm for 24 h to form a composite solution; the composite solution was transferred into a dialysis bag with a molecular weight cutoff of 5-10 kDa and placed in a 2 L ultrapure water system for dialysis to remove unstable impurities; after centrifugation to collect the precipitate, three-stage washing was carried out with ultrapure water (the centrifugation-resuspension cycle repeated three times); vacuum drying was carried out at 50 °C to obtain the Ce—FeOOH adsorption material C5 with a Ce doping amount of 10.9 wt %;
   (2) Extraction of eARGs:
S1. Escherichia coli DH5a carrying a plasmid with an ampicillin resistance gene (Amp) was used as a template strain. 0.1 mL of an engineered bacterial solution cryopreserved at −80 °C in glycerol was inoculated into 500 mL of an LB liquid medium containing 100 μg/mL Amp and cultured under oscillation at 37 °C and 180 rpm for 16 h until the logarithmic growth phase (OD₆₀₀=0.6-0.8);
S2. the bacterial solution was centrifuged at 4 °C and 4,000×g for 10 min to collect the bacterial cells, followed by plasmid extraction and purification; the extracted plasmids underwent plasmid integrity detection using a real-time fluorescent quantitative PCR (qPCR) system; after the plasmid purity was confirmed (A₂₆₀/A₂₈₀=1.82±0.05), the plasmids were subpackaged and stored in an ultra-low temperature freezer at −80 °C;

### (3) Adsorption Experiments of the Ce—FeOOH Adsorption Material C5 for Extracellular Resistance Gene (Amp) Contamination in Water:

S1. a 0.4 mL reaction system was established in a 2.0 mL sterile, enzyme-free EP tube, containing 0.1 mg/L Amp and 50 mg/L C5 adsorption material; the reaction system had a pH of 7.0±0.1 and a salinity of 10 mmol/L;
S2. the reaction system underwent a reaction under oscillation at 25 °C and 180 rpm; samples were collected at preset time points (0-360 min), and centrifuged at 4 °C and 12,000×g for 5 min; the supernatants were collected for qPCR detection; the residual concentration of the Amp resistance gene was calculated according to a standard curve.

### Example 2

This example showed the adsorption effect of a Ce—FeOOH adsorption material C5 at a dosage of 80 mg/L on extracellular resistance gene (Amp) contamination in water. The specific procedure was the same as that in Example 1.

### Example 3

This example showed the adsorption effect of a Ce—FeOOH adsorption material C5 on extracellular resistance gene (Amp) contamination in water when the concentration of the extracellular resistance gene (Amp) in the water was 0.025 mg/L, including the following steps:
S1. the method for preparing a Ce—FeOOH adsorption material C5 was the same as that in Example 1;
S2. a 0.2 mL reaction system was established in a 2.0 mL sterile, enzyme-free EP tube, containing 0.025 mg/L Amp and 40 mg/L C5 adsorption material; the reaction system had a pH of 7.0±0.1 and a salinity of 10 mmol/L;
S3. the reaction system underwent a reaction under oscillation at 25 °C and 180 rpm for 120 min, and centrifuged at 4 °C and 12,000×g for 5 min; the supernatants were collected for qPCR detection; the residual concentration of the Amp resistance gene was calculated according to a standard curve;
S4. adsorption data were fitted using Langmuir and Freundlich adsorption models: the formula for the Langmuir adsorption model was: Q=(Qₘbp)/(1+bp), where Q represented an adsorption capacity (mmol/g), Qₘ represented a saturated adsorption capacity (mmol/g), b represented an adsorption equilibrium constant, and p represented a partial pressure of a component (kPa); the formula for the Freundlich adsorption model was: Q=(Qₘbpⁿ)/(1+bpⁿ), where n represented a homogeneity index.

### Example 4

The difference between this example and Example 3 lied in the concentration of the extracellular resistance gene (Amp) in the water. In this example, the concentration of Amp was 0.05 mg/L.

### Example 5

The difference between this example and Example 3 lied in the concentration of the extracellular resistance gene (Amp) in the water. In this example, the concentration of Amp was 0.075 mg/L.

### Example 6

The difference between this example and Example 3 lied in the concentration of the extracellular resistance gene (Amp) in the water. In this example, the concentration of Amp was 0.1 mg/L.

### Example 7

The difference between this example and Example 3 lied in the concentration of the extracellular resistance gene (Amp) in the water. In this example, the concentration of Amp was 0.15 mg/L.

### Example 8

The difference between this example and Example 3 lied in the concentration of the extracellular resistance gene (Amp) in the water. In this example, the concentration of Amp was 0.2 mg/L.

### Example 9

The difference between this example and Example 3 lied in the concentration of the extracellular resistance gene (Amp) in the water. In this example, the concentration of Amp was 0.4 mg/L.

### Example 10

This example showed the adsorption effect of a Ce—FeOOH adsorption material C5 at a dosage of 50 mg/L on extracellular resistance gene (Amp) contamination in water when the pH of a water body to be treated was 4.0±0.1. The specific procedure was the same as that in Example 3.

### Example 11

The difference between this example and Example 10 lied in the pH of a water body to be treated. In this example, the pH of a water body to be treated was 5.0=0.1.

### Example 12

The difference between this example and Example 10 lied in the pH of a water body to be treated. In this example, the pH of a water body to be treated was 6.0±0.1.

### Example 13

The difference between this example and Example 10 lied in the pH of a water body to be treated. In this example, the pH of a water body to be treated was 7.0±0.1.

### Example 14

This example showed the adsorption effect of a Ce—FeOOH adsorption material C5 at a dosage of 50 mg/L on extracellular resistance gene (Amp) contamination in water when the salinity of a water body to be treated was 10 mmol/L. The specific procedure was the same as that in Example 3.

### Example 15

The difference between this example and Example 14 lied in the salinity of a water body to be treated. In this example, the salinity of a water body to be treated was 100 mmol/L.

### Example 16

The difference between this example and Example 14 lied in the salinity of a water body to be treated. In this example, the salinity of a water body to be treated was 500 mmol/L.

### Example 17

This example showed the effect of desorption and regeneration of a Ce—FeOOH adsorption material C5 using a 0.05 mol/L NaOH solution for 360 min while simultaneously achieving eARG elimination. The specific procedure was the same as that in Example 3.

### Example 18

The difference between this example and Example 17 lied in that in this example, the concentration of a NaOH solution was 0.1 mol/L.

### Example 19

The difference between this example and Example 17 lied in that in this example, the concentration of a NaOH solution was 0.2 mol/L.

### Example 20

This example showed the effect of Ce—FeOOH recycling after adsorption of a Ce—FeOOH adsorption material C5 on extracellular resistance gene (Amp) contamination in water, followed by regeneration of an adsorbent using a 0.05 mol/L NaOH solution while simultaneously achieving eARG elimination. The specific procedure was the same as that in Example 3.

To further illustrate the technical effects of the present disclosure, comparative examples are also provided in the present disclosure, specifically as follows:

### Comparative Example 1

In this comparative example, no adsorption material was added to an eARG-contaminated water body.

### Comparative Example 2

This comparative example showed the adsorption effect of a Ce-undoped FeOOH adsorption material C0 on extracellular resistance gene (Amp) contamination in water. The specific procedure was the same as that in Example 1.

### Comparative Example 3

This comparative example showed the adsorption effect of a Ce—FeOOH adsorption material C1 with a Ce doping amount of 1.5 wt % on extracellular resistance gene (Amp) contamination in water. The specific procedure was the same as that in Example 1.

### Comparative Example 4

The difference between this comparative example and Comparative Example 3 lied in the Ce doping amount of Ce—FeOOH. In this comparative example, the Ce doping amount of a Ce—FeOOH adsorption material C2 was 4.0 wt %.

### Comparative Example 5

The difference between this comparative example and Comparative Example 3 lied in the Ce doping amount of Ce—FeOOH. In this comparative example, the Ce doping amount of a Ce—FeOOH adsorption material C3 was 6.6 wt %.

### Comparative Example 6

The difference between this comparative example and Comparative Example 3 lied in the Ce doping amount of Ce—FeOOH. In this comparative example, the Ce doping amount of a Ce—FeOOH adsorption material C4 was 8.6 wt %.

### Comparative Example 7

This comparative example showed the adsorption effect of a Ce—FeOOH adsorption material C5 at a dosage of 10 mg/L on extracellular resistance gene (Amp) contamination in water. The specific procedure was the same as that in Example 1.

### Comparative Example 8

The difference between this comparative example and Comparative Example 7 lied in the dosage of a Ce—FeOOH adsorption material C5. In this comparative example, the dosage of an adsorption material C5 was 25 mg/L.

### Comparative Example 9

The difference between this comparative example and Comparative Example 7 lied in the dosage of a Ce—FeOOH adsorption material C5. In this comparative example, the dosage of an adsorption material C5 was 40 mg/L.

### Comparative Example 10

The difference between this comparative example and Comparative Example 7 lied in the dosage of a Ce—FeOOH adsorption material C5. In this comparative example, the dosage of an adsorption material C5 was 50 mg/L.

### Comparative Example 11

This comparative example showed the adsorption effect of a Ce—FeOOH adsorption material C5 at a dosage of 50 mg/L on extracellular resistance gene (Amp) contamination in water when the pH of a water body to be treated was 8.0±0.1. The specific procedure was the same as that in Example 3.

### Comparative Example 12

The difference between this comparative example and Comparative Example 11 lied in the pH of a water body to be treated. In this comparative example, the pH of a water body to be treated was 9.0±0.1.

### Comparative Example 13

The difference between this comparative example and Comparative Example 11 lied in the pH of a water body to be treated. In this comparative example, the pH of a water body to be treated was 10.0±0.1.

### Comparative Example 14

This comparative example showed the adsorption effect of a Ce—FeOOH adsorption material C5 at a dosage of 50 mg/L on extracellular resistance gene (Amp) contamination in water when the salinity of a water body to be treated was 0 mmol/L. The specific procedure was the same as that in Example 3.

### Comparative Example 15

This comparative example showed the effect of desorption and regeneration of a Ce—FeOOH adsorption material C5 using a 0.05 mol/L NaOH solution for 30 min while simultaneously achieving eARG elimination. The specific procedure was the same as that in Example 3.

### Comparative Example 16

The difference between this comparative example and Comparative Example 15 lied in that in this comparative example, the time for desorption and regeneration was 60 min.

### Comparative Example 17

The difference between this comparative example and Comparative Example 15 lied in that in this comparative example, the time for desorption and regeneration was 120 min.

### Comparative Example 18

This comparative example described the effect of desorption and regeneration of a Ce—FeOOH adsorption material C5 using a 0.1 mol/L NaOH solution for 30 min while simultaneously achieving eARG elimination. The specific procedure was the same as that in Example 3.

### Comparative Example 19

The difference between this comparative example and Comparative Example 18 lied in that in this comparative example, the time for desorption and regeneration was 60 min.

### Comparative Example 20

The difference between this comparative example and Comparative Example 18 lied in that in this comparative example, the time for desorption and regeneration was 120 min.

### Comparative Example 21

This comparative example described the effect of desorption and regeneration of a Ce—FeOOH adsorption material C5 using a 0.2 mol/L NaOH solution for 30 min while simultaneously achieving eARG elimination. The specific procedure was the same as that in Example 3.

### Comparative Example 22

The difference between this comparative example and Comparative Example 21 lied in that in this comparative example, the time for desorption and regeneration was 60 min.

### Comparative Example 23

The difference between this comparative example and Comparative Example 21 lied in that in this comparative example, the time for desorption and regeneration was 120 min.

### Comparative Example 24

This comparative example showed the adsorption effect of a metal Zn(II)-doped FeOOH adsorption material Zn—FeOOH on extracellular resistance gene (Amp) contamination in water. The specific procedure was the same as that in Example 1.

### Comparative Example 25

The difference between this comparative example and Comparative Example 24 lied in that in this comparative example, a doped metal was Cu(II).

### Comparative Example 26

The difference between this comparative example and Comparative Example 24 lied in that in this comparative example, a doped metal was Co(II).

### Comparative Example 27

The difference between this comparative example and Comparative Example 24 lied in that in this comparative example, a doped metal was Mn(II).

### Comparative Example 28

The difference between this comparative example and Comparative Example 24 lied in that in this comparative example, a doped metal was Fe(III).

### Comparative Example 29

This comparative example showed the adsorption effect of a Ce-doped Fe₃O₄ adsorption material Ce—Fe₃O₄ on extracellular resistance gene (Amp) contamination in water. The specific procedure was the same as that in Example 1.

The examples and comparative examples of the present disclosure are explained and illustrated below in conjunction with the accompanying drawings.

X-ray photoelectron spectroscopy (XPS) and Ce 3d and O 1s high-resolution spectra were performed on the Ce—FeOOH adsorption material C5 with a Ce doping amount of 10.9 wt % prepared in Example 1 and the Ce—FeOOH adsorption material C1 with a Ce doping amount of 1.5 wt % prepared in Comparative Example 3 according to the present disclosure. The results are summarized in Table 1. As can be seen from the analysis of elemental composition proportions in the survey spectrum, as the Ce doping amount increased, the content proportion of Ce increased from 1.51 wt % to 10.91 wt %. Analysis of the Ce 3d characteristic peaks of adsorption materials C1 and C5 revealed that Ce was supported on the surface of FeOOH in a form of a Ce(III) and Ce(IV) mixed-valence state. This was because during the impregnation process, the oxygen partial pressure and local redox environment in the solution might have promoted the partial oxidation of Ce³⁺ to Ce⁴⁺, resulting in the formation of the mixed valence state. Moreover, as the Ce doping amount increased, the content proportion of Ce(III) increased from 17.8% to 30.0%. Peak fitting of the O 1s characteristic peaks of the adsorption materials C1 and C5 exhibited a significant increase in hydroxyl oxygen (increasing from 41.12% to 51.82%). The results showed that the present disclosure successfully prepared Ce—FeOOH composite materials with different Ce doping amounts via the incipient wetness impregnation method; moreover, as the Ce doping amount increased, the proportion of Ce(III) ions gradually increased, and the hydroxyl oxygen content on the material surface increased. Through characterization analysis, it can be preliminarily predicted that when Ce substitutes for Fe on the surface of FeOOH, more surface hydroxyl groups are formed on the surface of FeOOH to balance the charge, thereby increasing the active sites for forming Fe—O—P complexation with DNA. Secondly, the affinity of Ce—OH for DNA is also stronger than that of Fe—OH. That is, the ionic radius of Ce³⁺ (1.14 Å) is much larger than that of Fe³⁺ (0.64 Å), resulting in a higher coordination number, and the surface Ce—OH groups expose more active sites due to coordination unsaturation. This provides the doped material with the potential to adsorb DNA through enhanced bimetallic coordination interactions. Similarly, other lanthanides with a structure similar to that of Ce, such as La³⁺, Eu³⁺, and Tm³⁺, also have larger ionic radii (0.9-1.2 Å) and higher coordination numbers, enabling the formation of more coordination-unsaturated Ln-OH active sites, and thus offering great potential in the design of FeOOH-based DNA adsorption materials.

TABLE 1
Summary of analysis of XPS survey spectrum and Ce 3 d and O 1
s high-resolution spectra for adsorption materials C1 and C5

| | Adsorption | Adsorption |
|---|---|---|
| Test indicator | material C1 | material C5 |
| Ce content | 1.51% | 10.92% |
| Ce(III)/(Ce(III) + Ce(IV)) | 17.83% | 29.99% |
| Hydroxyl oxygen content | 41.12% | 51.82% |

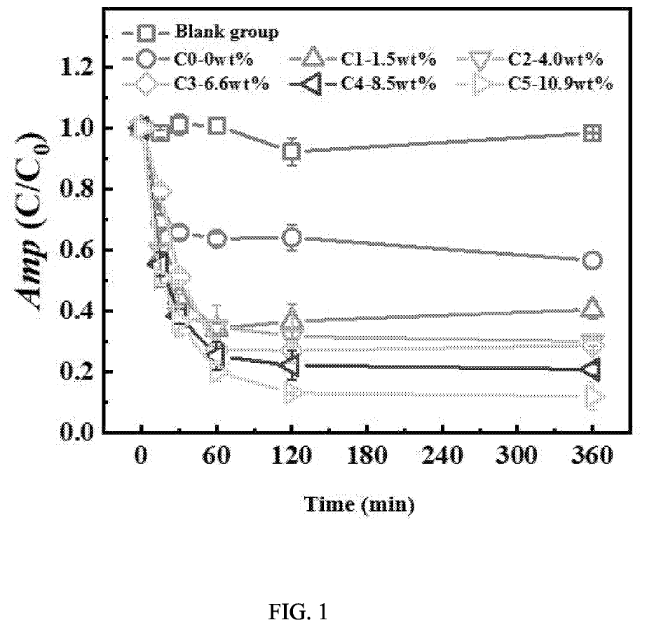

The adsorption effects of the adsorption material C5 prepared in Example 1, the adsorption materials C1-C4 prepared in Comparative Examples 3-6, no adsorption material added in Comparative Example 1, and the Ce-undoped FeOOH adsorption material C0 prepared in Comparative Example 2 according to the present disclosure on eARGs in the water body are shown in FIG. 1. Under the conditions of an initial Amp concentration of 0.1 mg/L and an adsorbent dosage of 50 mg/L, all of the adsorption materials C1-C5 and C0 exhibited adsorption phenomena. As the Ce doping amount increased, the adsorption effect on Amp was significantly enhanced. At an adsorption time of 120 min, the Ce—FeOOH adsorption material with a Ce doping amount of 10.9% was capable of adsorbing 86.25% of Amp, representing an increase of 51.0% compared with the Ce-undoped FeOOH adsorption material C0 (35.90%). In summary, the doping of Ce on the surface of FeOOH effectively enhances the adsorption effect on eARGs, and the adsorption effect is directly proportional to the doping amount.

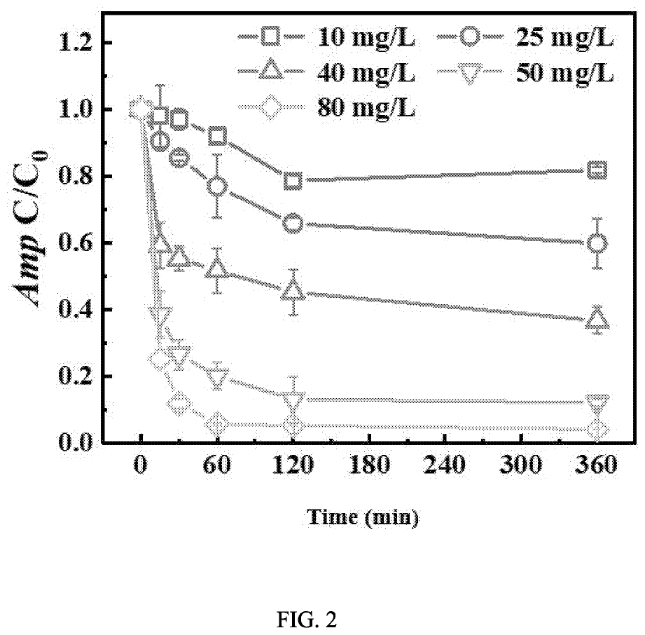

Example 2 and Comparative Examples 7-10 according to the present disclosure showed the adsorption effects of the FeOOH adsorption material C5 (with a Ce doping amount of 10.9%) at different dosages on eARGs in the water body. As shown in FIG. 2, at an initial Amp concentration of 0.1 mg/L, the adsorption performance of the adsorption material C5 on Amp was significantly enhanced as the dosage increased. At a dosage of 80 mg/L, 88.23% of Amp could be removed after just 30 minutes of adsorption. When the adsorption time was prolonged to 120 min, all experimental groups reached adsorption equilibrium (A adsorption capacity <10%), and no significant desorption phenomenon was observed after equilibrium.

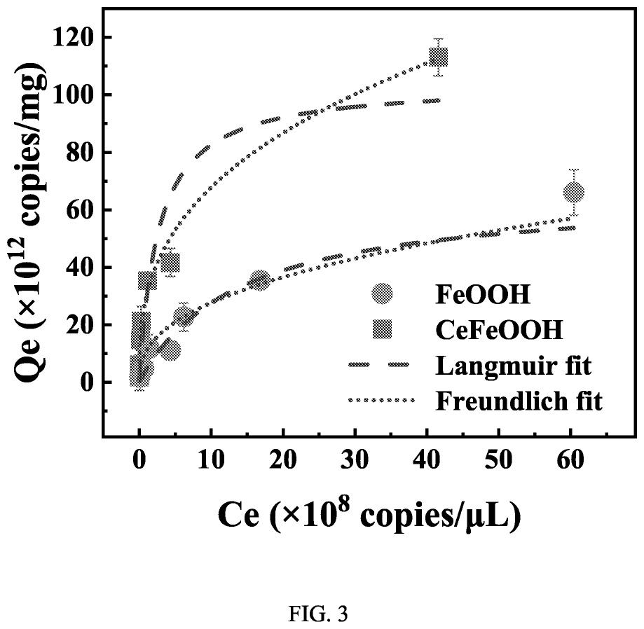

Examples 3-9 according to the present disclosure showed the adsorption effects of the Ce—FeOOH adsorption material C5 on extracellular resistance genes (Amp) in water at concentrations of 0.025, 0.05, 0.075, 0.1, 0.15, 0.2, and 0.4 mg/L. The adsorption data were fitted using Langmuir and Freundlich isotherm models, with the FeOOH adsorption material C0 prepared in Comparative Example 2 serving as a control group. As shown in FIG. 3, the adsorption data for both adsorption materials fit the Langmuir model well (FeOOH: R²=0.96; Ce—FeOOH: R²=0.94), indicating that their adsorption behavior is dominated by monolayer chemisorption. The maximum adsorption capacity of the adsorption material C0 was 1.9×10¹³ copies/mg, whereas the maximum adsorption capacity of the adsorption material C5 was significantly increased to 2.2×10¹⁴ copies/mg, representing an 11.5-fold increase over the adsorption material C0. This difference confirms that the introduction of Ce effectively enhances the capture capacity for eARGs by regulating the surface adsorption sites and charge distribution properties of the material.

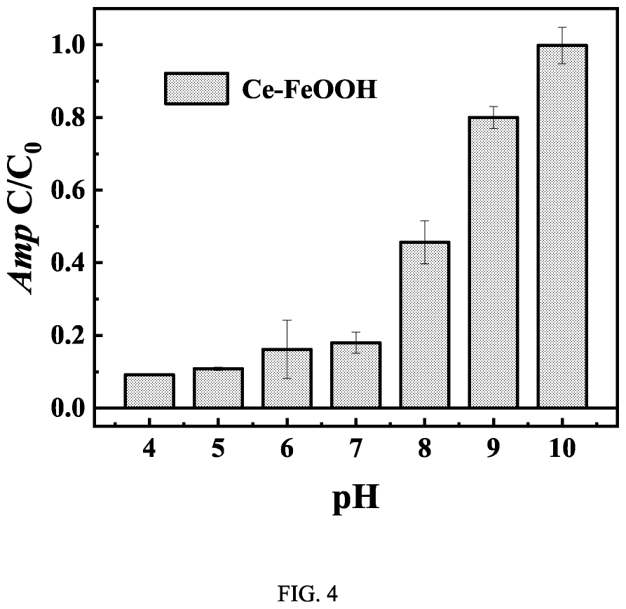

Examples 10-13 and Comparative Examples 11-13 according to the present disclosure showed the adsorption effects of the Ce—FeOOH adsorption material C5 at different pH values on eARGs in the water body. As shown in FIG. 4, when pH≤7.0±0.1, the adsorption efficiency was greater than 80.0%, and the adsorption effect was improved as the pH value decreased. In contrast, when pH=8.0±0.1, the adsorption effect decreased by 21.5% compared with that at pH=7±0.1; at pH=9.0±0.1, the effect decreased by 66.9%; and at pH=10.0±0.1, adsorption was inhibited. In summary, the doped material Ce—FeOOH exhibits a stable removal effect on eARGs over a wide pH range.

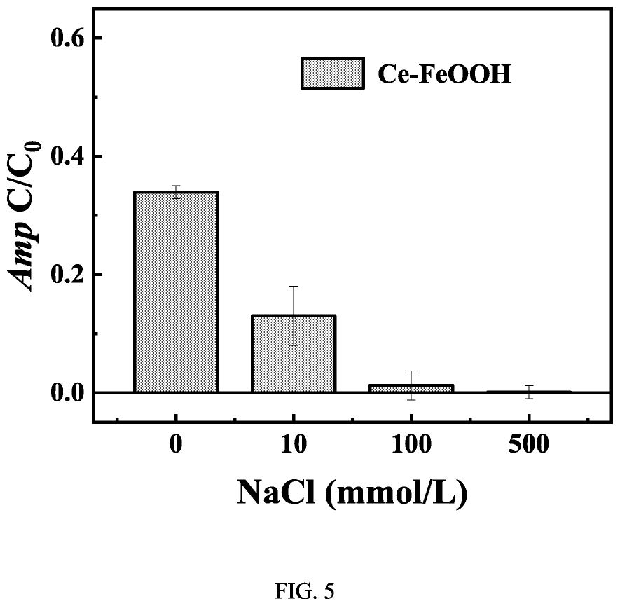

Examples 14-16 and Comparative Example 14 according to the present disclosure showed the adsorption effects of the Ce—FeOOH adsorption material C5 at different salinities on eARGs in the water body. As shown in FIG. 5, the adsorption effect was gradually increased as the NaCl concentration in the water body increased; in a freshwater system (10 mmol/L NaCl), the adsorption effect reached 86.9%, representing an increase of 10.6% compared with no ionic strength (66.1%); when the NaCl concentration was 100-500 mmol/L, the adsorption effect was increased by 32.7-33.9%, representing a significant improvement compared with the freshwater environment. In summary, the doped material Ce—FeOOH can adapt to the adsorption and removal of eARGs under conditions of water bodies with different NaCl concentrations. Therefore, if it is desired to improve the adsorption and removal effect of Ce—FeOOH on eARGs, the pH value of the water environment or the ionic strength of the water body can be appropriately increased.

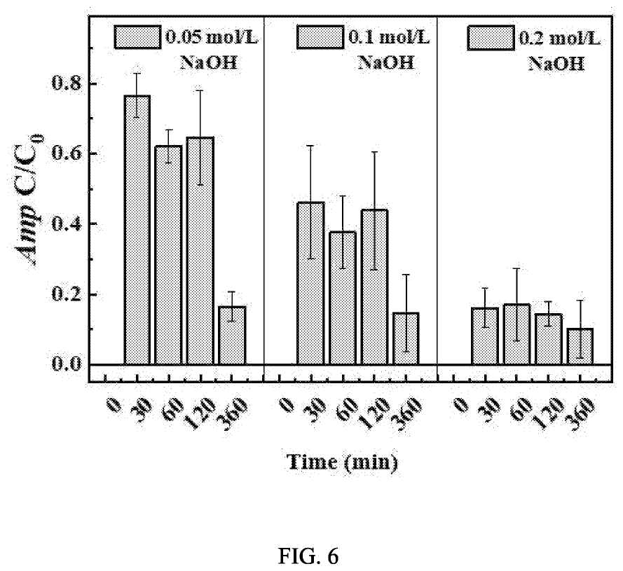

Example 17 and Comparative Examples 15-17 showed the effects of regeneration of an adsorbent using a 0.05 mol/L NaOH solution for 360 min, 30 min, 60 min, and 120 min while simultaneously achieving eARG elimination after adsorption of extracellular resistance gene (Amp) contamination in water by the adsorption material C5. Example 18 and Comparative Examples 18-20 showed the effects of regeneration of an adsorbent using a 0.1 mol/L NaOH solution for 360 min, 30 min, 60 min, and 120 min while simultaneously achieving eARG elimination after adsorption of extracellular resistance gene (Amp) contamination in water by the adsorption material C5. Example 19 and Comparative Examples 21-23 showed the effects of regeneration of an adsorbent using a 0.2 mol/L NaOH solution for 360 min, 30 min, 60 min, and 120 min while simultaneously achieving eARG elimination after adsorption of extracellular resistance gene (Amp) contamination in water by the adsorption material C5. The results are shown in FIG. 6. When the NaOH concentration was 0.05 mol/L, the degradation efficiency of eARGs reached 23.44% within 30 min; when the NaOH concentration was 0.1 mol/L, the degradation efficiency of eARGs increased to 53.87% within 30 min. When the NaOH concentration was increased to 0.2 mol/L or above, the degradation efficiency of eARGs exceeded 83.87% within 30 min, achieving effective elimination of the adsorbed eARGs. This is attributed to the characteristics of the NaOH solution. On the one hand, the strong alkaline solution can completely dissociate into hydroxyl ions in the water body, which substitute for the phosphate groups on the adsorbed eARGs, leading to desorption of the eARGs and regeneration of the adsorbent; meanwhile, the high pH exhibited by the NaOH solution enables substantial degradation of the eARGs.

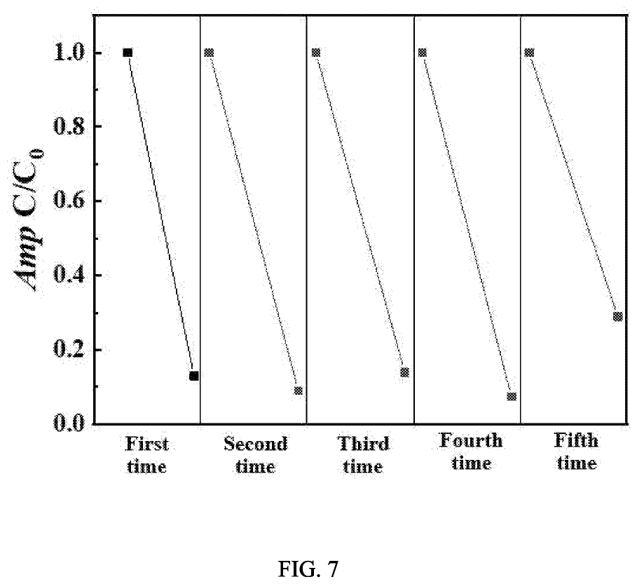

Example 20 according to the present disclosure showed the effect of recycling of the adsorption material C5 after regeneration of the adsorption material using a 0.05 mol/L NaOH solution while simultaneously achieving eARG elimination. As shown in FIG. 7, the Ce—FeOOH adsorption material exhibited good adsorption performance for eARGs after the adsorption-regeneration cycle experimental period. After five adsorption-desorption cycles, the adsorption performance of the Ce—FeOOH adsorption material decreased by 15.95%, demonstrating good regenerability and reusability.

In summary, NaOH, serving as a regeneration solution, can complete the regeneration of the adsorbent within 30 min. If it is desired to simultaneously achieve effective degradation of eARGs during the elution and regeneration process, it is necessary to prolong the elution time or increase the NaOH concentration. In addition, the Ce—FeOOH adsorbent regenerated with NaOH exhibits good recyclability.

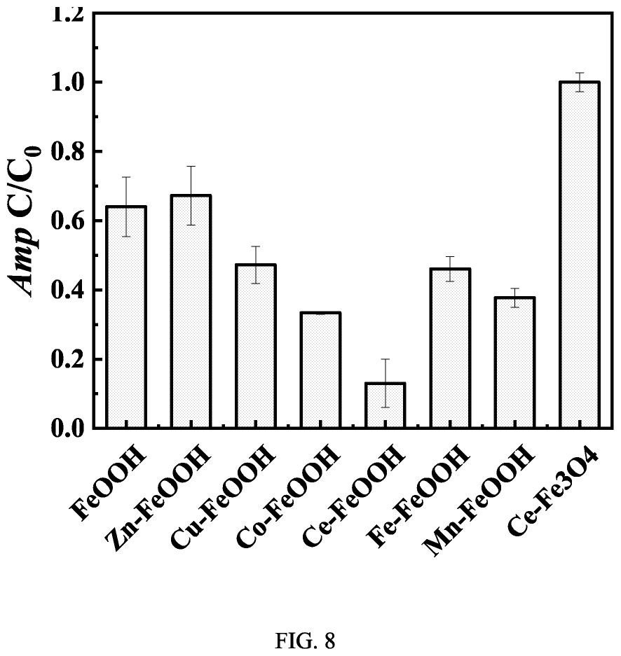

The comparison of adsorption effects on Amp between the adsorption materials with goethite doped with different metals in Comparative Examples 24-28 and the Ce-doped Fe₃O₄ adsorption material in Comparative Example 29 according to the present disclosure is shown in FIG. 8. Under the same pollutant concentration and the same adsorbent dosage, Ce-doped goethite exhibited the best adsorption effect on Amp, with C/C₀ of 0.13 at 120 min, which is significantly lower than that of doping with other metals, such as Zn (C/C₀=0.67), Cu (C/C₀=0.47), Co (C/C₀=0.33), Fe (C/C₀=0.46), and Mn (C/C₀=0.38). This indicates that among typical material modifications of goethite doped with transition metals and lanthanide metals, the lanthanide metals represented by Ce exhibit outstanding effects and advantages in the application of modified goethite adsorbents for the removal of extracellular resistance genes. In addition, when Ce was doped onto the surface of other substrates (such as magnetite Fe₃O₄) for eARG adsorption, no significant adsorption effect was observed. This reflects the specificity of Ce bonding with FeOOH and its superiority in the application of adsorbing extracellular resistance genes.

The above descriptions are merely the preferred embodiments of the present disclosure. The scope of protection of the present disclosure is not limited to the above examples, and any technical solutions falling within the concept of the present disclosure shall be considered within the scope of protection of the present disclosure. It should be noted that for those of ordinary skill in the art, several improvements and modifications, made without departing from the principle of the present disclosure, should also be regarded as falling within the protection scope of the present disclosure.

What is claimed is:

1. A cerium-doped goethite adsorption material, wherein the cerium-doped goethite adsorption material Ce—FeOOH consists of goethite FeOOH doped with metal cerium Ce; the Ce is supported on a surface of the FeOOH in a form of a Ce(III) and Ce(IV) mixed-valence state, and a proportion of Ce(III) is 17.8-30.0%; and a method for preparing the cerium-doped goethite adsorption material Ce—FeOOH comprises the following steps:
S1. precursor treatment: placing FeOOH particles in a low-concentration acid solution to react under oscillation, then washing until neutral, and carrying out vacuum drying to obtain pre-treated FeOOH; and
S2. Ce ion supporting and purification: dissolving a cerium salt in water to obtain a cerium salt solution, mixing the cerium salt solution with the FeOOH, carrying out ultrasonic dispersion, and then carrying out a reaction under oscillation to form a composite solution; and finally, subjecting the composite solution to dialysis, and carrying out vacuum drying to obtain a Ce-doped FeOOH adsorption material.

2. The cerium-doped goethite adsorption material according to claim 1, wherein in step S1, the low-concentration acid solution is one or more of nitric acid, hydrochloric acid, and sulfuric acid solutions; and/or
in step S1, a time for the reaction under oscillation is 20-40 min, and a temperature for the vacuum drying is 40-60 °C; and/or
in step S2, the cerium salt solution is any one or more of cerium chloride, cerium nitrate, cerium sulfate, and hydrates thereof; and/or
in step S2, a doping amount of the Ce in the FeOOH is 1.5-10.9 wt %; and/or
in step S2, for the ultrasonic dispersion, a frequency is 30-50 kHz, and a time is 20-40 min; for the reaction under oscillation, a temperature is 23-26 °C, a rotation speed is 170-190 rpm, and a time is 22-26 h.

3. Use of the Ce—FeOOH adsorption material according to claim 1 in removal of extracellular antibiotic resistance genes (eARGs) from a water body, wherein the eARGs in the water body are any one or more of an extracellular eARG fragment in a free form, and a plasmid or genome carrying an eARG fragment.

4. The use according to claim 3, wherein a method for removing the eARGs from the water body using the Ce—FeOOH adsorption material comprises the following steps:
S1. adjusting a pH of an eARG-contaminated water body to be treated to (4.0-8.0)±0.1, and adjusting a salinity of the water body to be treated to ≥10 mmol/L using a neutral salt;
S2. dispersing the Ce—FeOOH adsorption material into the water body to be treated, mixing under oscillation at 23-26 °C and 170-190 rpm for 30-120 min, and separating a Ce—FeOOH-eARGs complex via centrifugation; and
S3. immersing the complex in a NaOH solution for desorption, thereby achieving elimination of the eARGs and desorption and regeneration of the Ce—FeOOH material.

5. The use according to claim 4, wherein when the pH of the water body to be treated in step S2 is 7.0±0.1, the salinity of the water body to be treated needs to be adjusted to ≥10 mmol/L, and a dosage of the Ce—FeOOH adsorption material is ≥80 mg/L.

6. The use according to claim 4, wherein when the water body to be treated in step S2 satisfies one or more of pH<7.0±0.1 or salinity >10 mmol/L, a Ce—FeOOH adsorption material with a Ce doping amount of 10.9% is selected, and one or more of methods including an adsorption material dosage of 50-80 mg/L or shortening an adsorption time to 30-60 min is utilized.

7. The use according to claim 4, wherein in step S3, a concentration of the NaOH solution is 0.05-0.2 mol/L, a time for the desorption is 30-360 min, the regeneration of the Ce—FeOOH adsorption material can be achieved while simultaneously achieving an eARG elimination rate of 75-90%, and a number of times of recycling of the material after the desorption and regeneration is ≥4.

8. The use according to claim 4, wherein a concentration of the eARGs in the water body to be treated is ≤1×10¹³ copies/L.

9. The use according to claim 3, wherein an adsorption capacity of the Ce—FeOOH adsorption material for removing the eARGs from the water body is ≤2.2×10¹⁴ copies/mg.
